(19) United States
(12) Patent Application Publication
(10) Pub. No.: US 2009/0328115 A1
(43) Pub. Date: Dec. 31, 2009

(54) Systems and Methods for Distributing Digital Content

(75) Inventor: Dale Malik, Dunwoody, GA (US)

Correspondence Address: AT&T Legal Department - LNA;Attn: Patent Docketing, Room 2A- 207, One AT & T Way, Bedminster, NJ, 07921, US

(73) Assignee: AT&T DELAWARE INTELLECTUAL PROPERTY, INC., Wilmington, DE (US)

(21) Appl. No.: 12/163,282

(22) Filed: Jun. 27, 2008

(51) Int. Cl. H04N 7/173

(52) U.S. Cl. 725/93; 725/100

(57) ABSTRACT

A method for distributing digital content can include receiving a first request from a first client for a digital content of the plurality of digital content and providing a first portion of the digital content to the first client. The method can further include receiving a second request from a second client for the digital content after providing the first portion of the digital content to the first client and providing a second portion of the digital content as a multicast stream to the first and second clients. Additionally, the method can include sending an offer to the second client to skip the first portion of the digital content.

### FIELD OF THE DISCLOSURE

The present disclosure generally relates to communications networks, and more particularly relates to systems and methods for distributing digital content.

### BACKGROUND

Multicasting of digital content such as video streams has been proposed in order to eliminate duplicate streams flowing through common links in a network. A single multicast stream of live or broadcast content can be provided to multiple users without the overhead and bandwidth required to provide multiple unicast streams to each respective user. Multicasting of digital content scales with the number of individual streams started, and can be independent of the number of individual users. Multicasting, while effective for streaming live content, comes with complications in the Video on Demand (VoD) area. For example, users may request VoD content at times other than when a multicast stream starts.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network in accordance with one embodiment of the present disclosure;

FIG. 2 is a diagram illustrating a digital information distribution network in accordance with one embodiment of the present disclosure;

FIGS. 3 through 5 are flow diagrams illustrating exemplary methods of distributing digital content;

FIG. 6 is a block diagram illustrating distribution of digital content; and

FIG. 7 is an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

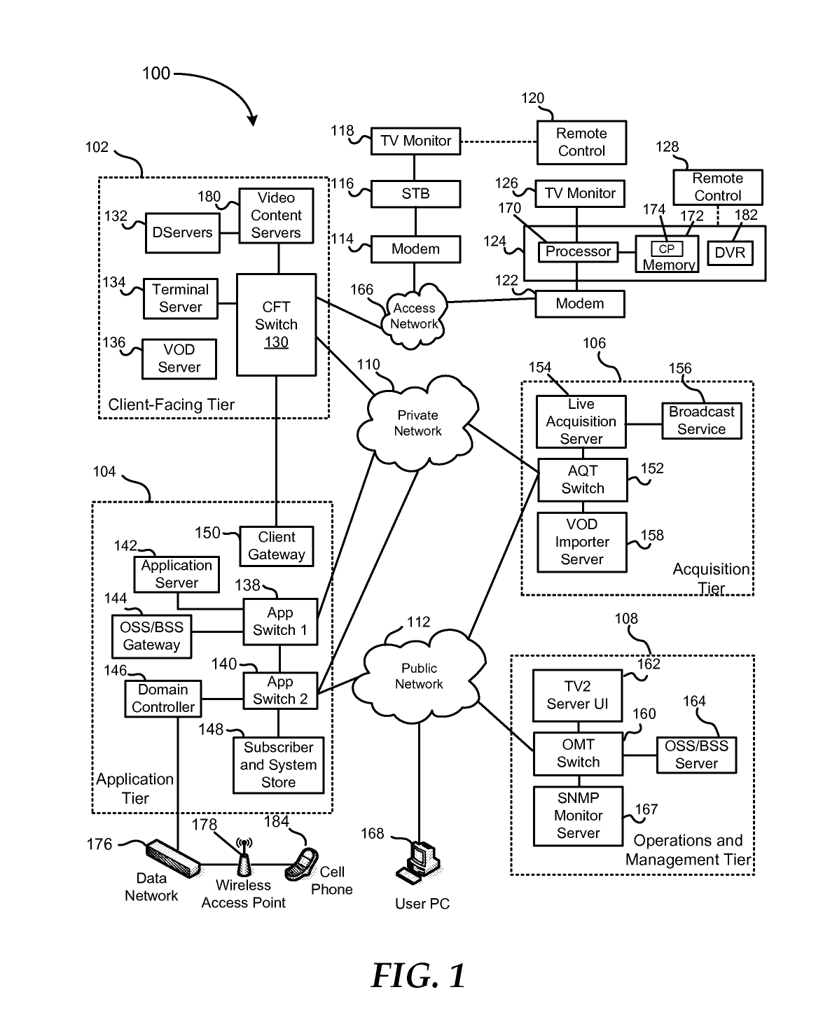

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box (STB) device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include an STB processor 170 and an STB memory device 172 that is accessible to the STB processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VoD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VoD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VoD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VoD importer server 158 can receive content from one or more VoD sources outside the IPTV system 100, such as movie studios and programmers of non-live content. The VoD importer server 158 can transmit the VoD content to the AQT switch 152, and the AQT switch 152 in turn can communicate the material to the CFT switch 130 via the private network 110. The VoD content can be stored at one or more servers, such as the VoD server 136.

When a user issues a request for VoD content to the set-top box device 116 or 124, the request can be transmitted over the private access network 166 to the VoD server 136 via the CFT switch 130. Upon receiving such a request, the VoD server 136 can retrieve requested VoD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The STB computer program 174 can contain instructions to receive many types of user preferences from the domain controller 146 via the access network 166. For example, the STB computer program 174 can include instructions to receive a request to record at least one television program at a video content storage module such as a digital video recorder (DVR) 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

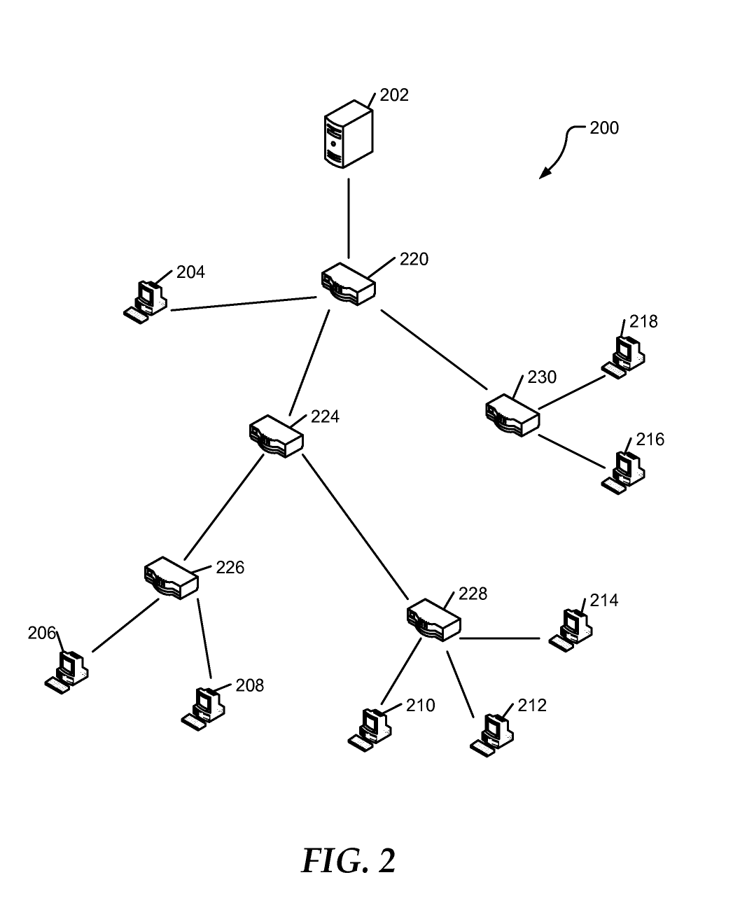

FIG. 2 shows a multicast tree 200 for distributing digital content through a network, such as IPTV system 100. Multicast tree 200 can include a server 202, such as VoD server 136, and client systems 204 through 218, such as STB 128. Server 202 and client systems 204 through 218 can communicate through a network of distribution points 220 through 230. The distribution points 220 through 230 may be routers. Alternatively, the distribution points 220 through 230 may be nodes of an overlay network. For example, communication from server 202 can travel through distribution points 220, 224, and 226 to client system 208 while communication from server 202 can travel through distribution points 220 and 230 to client 216.

Server 202 can use IP multicast to substantially simultaneously distribute VoD content, such as a movie or pay-per-view sporting event, to the client systems 204 through 218. The VoD content can be divided into multiple data packets. Using IP multicast, the server 202 can send one copy of each data packet. The distribution points 220 through 230 can create copies where the paths to the destinations split. For example, server 202 can send a multicast data packet to distribution point 220. Distribution point 220 can send a copy of the data packet to each of client 204, distribution point 224, and distribution point 230. Similarly, distribution point 230 can send a copy of the data packet to each of client systems 216 and 218, and distribution point 224 can send a copy of the data packet to each of distribution points 226 and 228. Further, distribution point 226 can send a copy of the data packet to each of client systems 206 and 208 and distribution point 228 can send a copy of the data packet to each of client systems 210, 212, and 214.

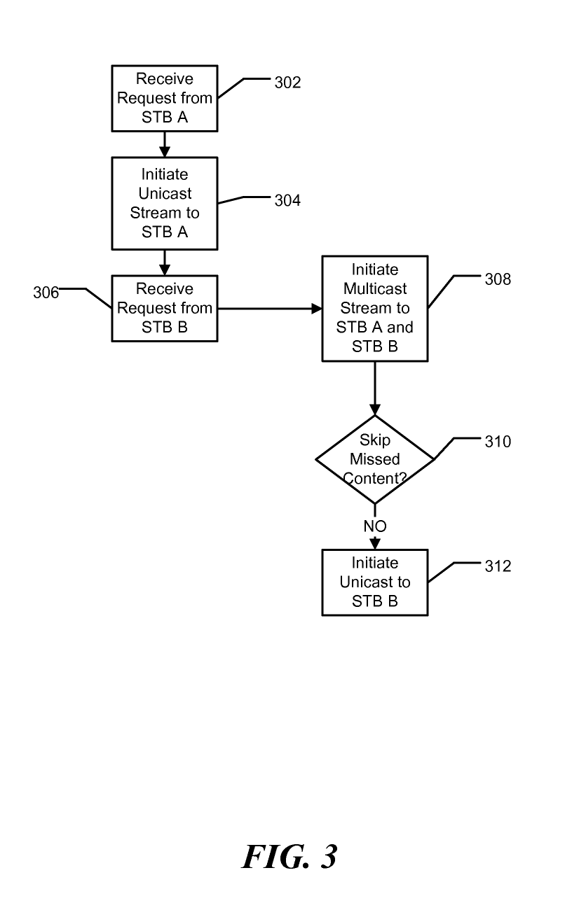

FIG. 3 shows a flow diagram for providing a multicast stream for VoD content. At 302, a VoD server, such as VoD server 136, can receive a request from an STB A, such as STB 124. The request can identify VoD content requested by a viewer. At 304, the VoD server can initiate a unicast stream of the VoD content to STB A. At 306, the VoD server can receive a request from an STB B for the VoD content. At 308, the VoD server can initiate a multicast stream of the VoD content and instruct STB A and STB B to join the multicast stream. The multicast stream can stream content from the current viewing point of STB A. At 310, the VoD server can notify STB B of an offer to miss a prior portion of the content. The offer can include an incentive for the viewer to skip the prior portion of the content, such as a discount on the purchase price of the VoD content. When the viewer declines the offer, the server initiates a unicast to provide fill-in content to STB B, as illustrated at 312. The fill-in content can be the prior portion of the VoD content. Additionally, the VoD server can provide STB B with information about the multicast stream, such as the current timestamp, such that STB B can cache the multicast stream and combine the unicast stream with the multicast stream for playback. Alternatively, when the viewer accepts the offer to skip the prior portion of the VoD content, the VoD server does not need to provide a unicast stream of the prior portion of the VoD content.

In an exemplary embodiment, the VoD server can initiate a multicast stream to STB A to deliver the VoD content. When STB B requests the VoD content, STB B can join the multicast stream. An offer to skip the prior portion of the VoD content can be sent to STB B, and a unicast stream of the prior portion of the VoD content can be provided when STB B rejects the offer.

In another exemplary embodiment, a user of STB A can request a private group multicast of the VoD content. Pricing of the VoD content can depend on the number of STBs joining the private group multicast. For example, a user of STB B may receive a discount on the purchase price for joining the private group multicast after missing an initial portion of the VoD content, and the user of STB A may receive a credit based on the number of users that join the private group multicast.

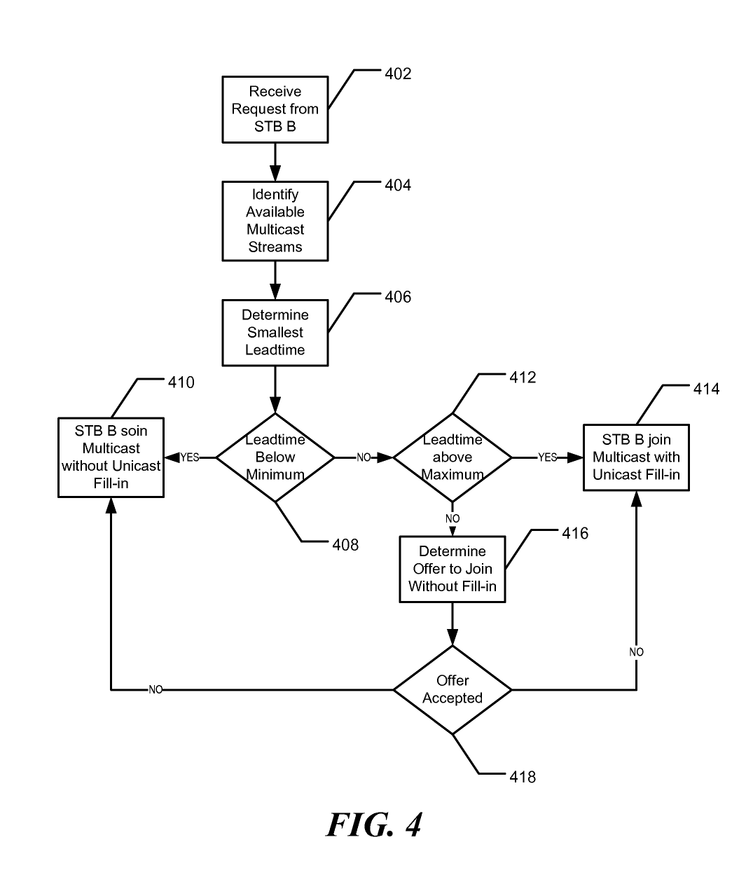

FIG. 4 shows a flow diagram illustrating for providing a multicast stream of VoD content. At 402, the VoD server such as VoD server 136 can receive a request for VoD content from a STB such as STB 124. The VoD server can include a VoD Stream Manager that maintains a table of content streams currently provided by the VoD server. The VoD Stream Manager may be software, hardware, or any combination thereof. At 404, the VoD Stream Manager can identify available multicast streams for the content. Additionally, the VoD Stream Manager can identify unicast streams that can be converted to multicast streams. At 406, the VoD Stream Manager can determine the multicast stream with the smallest lead-time. The lead-time can be the amount of time between the beginning of the content and the current point of the multicast stream. At 408, the VoD Stream Manager can determine if the lead-time is below a minimum. The minimum time can be a small amount of time that will generally still be within the opening credits of the VoD content, such as less than 30 seconds. When the lead-time is below the minimum, the VoD Stream Manage can instruct the STB to join the multicast without receiving a unicast of the fill-in content, as illustrated at 410.

Returning to 408, when the lead-time is above the minimum, the VoD Stream Manager can determine if the lead-time is above a maximum, as illustrated at 412. When the lead-time not above the maximum, the VoD Stream Manager can instruct the STB to join the multicast and initiate a unicast to STB to provided the fill-in content, as illustrated at 414. The VoD Stream Manager can add an entry to the table corresponding to the unicast stream of the fill-in content. The entry can include a marker at a position in the content that is substantially the same as the current point of the multicast stream. The VoD Stream Manager can provide the unicast stream of the content up to the marker. When the marker is reached, the unicast stream can end and the STB can continue playback from the cached multicast stream. The end of the unicast stream and the beginning of the cached multicast stream can overlap to prevent missing a portion of the content.

Returning to 412, when the lead-time is above the maximum, the VoD Stream Manager can determine an offer to join without receiving fill-in content, as illustrated at 416. The offer can be based on the amount of fill-in content required. For example, longer lead-times can result in larger discounts, due to the larger cost of providing the fill-in content as a unicast stream. At 418, the VoD Stream Manager can provide the offer to the STB and determine if the offer is accepted. When the offer is accepted, the STB can join the multicast stream without receiving a unicast of the fill-in content, as illustrated at 410. Alternatively, when the offer is not accepted, the STB can join the multicast stream and the VoD Server can provide the fill-in content as a unicast stream to the STB, as illustrated at 414.

In another exemplary embodiment, the VoD Stream Manager can monitor the current demand for the VoD content. When a STB requests VoD content that is frequently requested, the VoD Stream Manager may instruct the STB to wait a period of time to allow additional requests for the VoD content to enable consolidating the requests into a single multicast stream. The period of time can be short, such as less than a few minutes, such that the user still feels the content is available on demand.

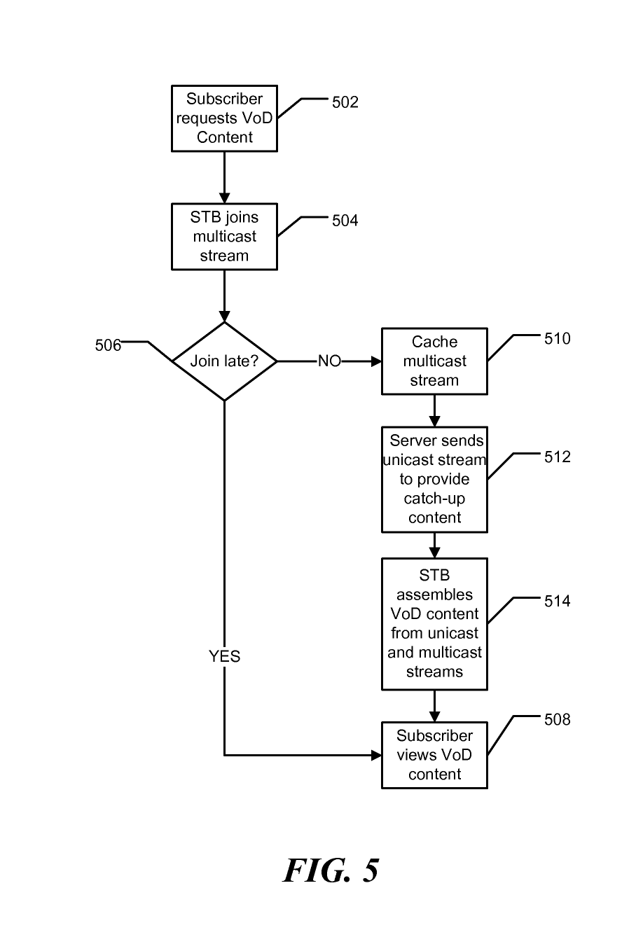

FIG. 5 shows a flow diagram for receiving a multicast stream for VoD content. At 502, a subscriber may request VoD content. At 504, an STB can join a multicast stream. The multicast stream can be an existing multicast stream providing a later portion of the VoD content to other subscribers. The multicast stream allows the server to provide the same VoD content to a relatively large number of subscribers with minimal server overhead. At 506, the STB can provide the viewer with an option to miss a portion of the VoD content by viewing the VoD content from the current point of the multicast stream. In an exemplary embodiment, the viewer can be offered an incentive to miss a portion of the VoD content, such as by receiving a discount, a rebate, a credit, or any combination thereof. At 508, when the viewer accepts the offer, the STB can begin displaying the multicast stream to the viewer.

Alternatively, at 510, when the viewer does not accept the offer, the STB can cache the VoD content from the multicast stream for later playback. At 512, the VoD server sends a unicast stream to provide missed VoD content. The missed VoD content can be an earlier portion of the VoD content that is not available through the multicast stream. For example, if the subscriber requests a movie, the STB may join the multicast stream five minutes into the movie and missed VoD content can include the first five minutes of the movie. At 514, the STB assembles the VoD content from the unicast stream and the multicast stream, so that the subscriber can view the VoD content, as illustrated at 508. By combining the unicast missed VoD content with the multicast VoD content, the subscriber can view the VoD content from the beginning.

In an exemplary embodiment, the STB may join multiple multicast streams to retrieve the VoD content. The number of multicast streams can depend on the available storage capacity and the available bandwidth of the STB. For example, a first multicast stream may be currently providing VoD content from the first portion of a video, and a second multicast stream may be currently providing VoD content from a second portion of the video. The STB may join the first multicast stream to receive the first portion, and simultaneously join the second multicast stream to receive the second portion. The STB can cache the second segment from the second multicast stream and when the first multicast stream reaches the second segment, the STB can leave the first multicast stream and continue playback from the cached data from the second multicast stream. Additionally, the viewer can jump between the first segment and the second segment, such as by fast forwarding or reversing playback.

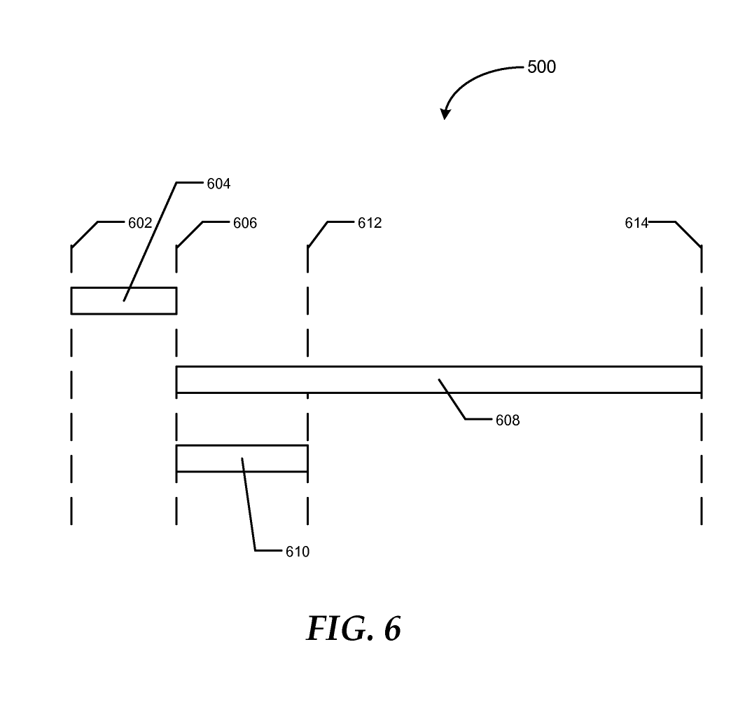

FIG. 6 illustrates a timeline 600 for providing a multicast stream of VoD content according to an aspect of the disclosure. At time point 602, a VoD server such as VoD server 136 can provide a unicast stream 604 of VoD content to an STB A, such as STB 124. In an example, time point 602 can be a time t and the VoD content can last 120 minutes. At time point 606, the VoD server can receive a request from an STB B for the same VoD content. In the example, time point 606 can be 30 minutes after the beginning of the VoD content, such at t+30 min. The VoD server can provide a multicast stream 608 to both STB A and STB B including the VoD content from the current viewing point of STB A. STB B can cache the VoD content from multicast stream 608 for later playback. Additionally, the VoD server can provide a unicast stream 610 of a prior portion of the VoD content previously received by STB A. In the example, the prior portion of the VoD content is the initial 30 minutes of the VoD content and the multicast stream 608 can provide the remaining 90 minutes of the VoD content. At time point 612, the unicast stream of the prior portion of the VoD content can end and STB B can begin playback of the cached VoD content from the multicast stream 608. In the example, time point 612 can be t+60 minutes, such as 30 minutes after time point 606 to allow for deliver of unicast stream 610. At time point 614, multicast stream 608 can end and STB A can complete playback of the VoD content. Time point 614 can be t+120 minutes, such as to provide STB with the entire 120 minutes of the VoD content. STB B can continue to play back VoD content cached from multicast stream 608 until playback is completed.

In an exemplary embodiment, a STB can receive and cache content from multiple multicast streams. For example, the first STB can request a VoD content lasting 90-minute. The first STB can receive an initial 30 minutes of fill-in content as a unicast stream. Further, the first STB can receive a middle 30 minutes as part of a first multicast stream and a final 30 minutes as part of a second multicast stream. Additionally, the VoD Stream Manager can maintain a table of streams that are currently provided the VoD server. The table can include a marker indicating the end of the content required by the content stream. The marker for the multicast stream providing the middle 30 minutes can indicate that the multicast stream can stop at 60 minutes into the VoD content, where the first STB can begin playback of the cached second multicast stream. When a second STB requests the VoD content 5 minutes after the first STB, the unicast stream providing fill-in to the first STB can be converted to a third multicast stream and a unicast stream to the second STB can provide the first 5 minutes of the VoD content. Additionally, the second STB can receive the first and second multicast stream. The VoD Stream Manager can update the record of the first multicast stream to indicate that an additional 5 minutes needs to be provided to account for the second STB missing the previous 5 minutes of the second STB. Alternatively, the first multicast stream can end as before, and the missing 5 minutes between the end of the first multicast stream and the point where the second STB picked up the second multicast stream can be provided to the second STB as an additional unicast stream.

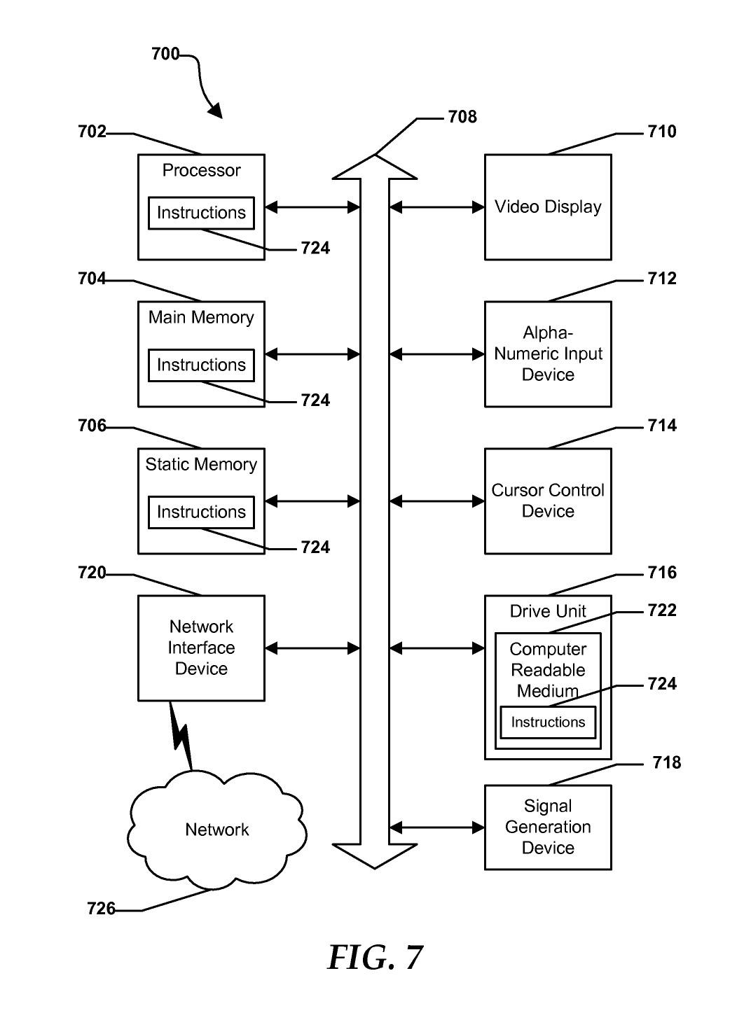

FIG. 7 shows an illustrative embodiment of a general computer system 700. The computer system 700 can include a set of instructions that can be executed to cause the computer system to perform any one or more of the methods or computer based functions disclosed herein. The computer system 700 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, an STB, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

The computer system 700 may include a processor 702, such as a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710 such as a liquid crystal display (LCD), an organic light emitting diode (OLED), a flat panel display, a solid-state display, or a cathode ray tube (CRT). Additionally, the computer system 700 may include an input device 712 such as a keyboard, and a cursor control device 714 such as a mouse. The computer system 700 can also include a disk drive unit 716, a signal generation device 718 such as a speaker or remote control, and a network interface device 720 to communicate with a network 726. In a particular embodiment, the disk drive unit 716 may include a computer-readable medium 722 in which one or more sets of instructions 724, such as software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method for distributing digital content, comprising:
receiving a first request from a first client for digital content;
providing a first portion of the digital content to the first client;
receiving a second request from a second client for the digital content after providing the first portion of the digital content to the first client;
providing a second portion of the digital content as a multicast stream to the first and second clients; and
sending an offer to the second client to skip the first portion of the digital content.

2. The method of claim 1, wherein the offer includes a discount, a credit, a rebate, or any combination thereof.

3. The method of claim 1, wherein providing the first portion of the digital content includes providing a unicast stream to the first client.

4. The method of claim 1, further comprising providing the first portion of the digital content to the second client when the client declines the offer.

5. The method of claim 4, wherein providing the first portion of the digital content to the second client includes providing a unicast stream to the second client.

6. The method of claim 1, wherein the digital content is video-on-demand content.

7. A digital content distribution system comprising:
a storage including digital content; and
a processor in communication with the storage, the processor configured to:
receive a first request from a first client for digital content;
provide a first portion of the digital content to the first client;
receive a second request from a second client for the digital content after providing the first portion of the digital content to the first client;
provide a second portion of the digital content as a multicast stream to the first and second clients; and
send an offer to the second client to skip the first portion of the digital content.

8. The digital content distribution system of claim 7, wherein the offer includes a discount, a credit, a rebate, or any combination thereof.

9. The digital content distribution system of claim 7, wherein the processor is configured to provide the first portion of the digital content in a unicast stream to the first client.

10. The digital content distribution system of claim 7, wherein the processor is further configured to provide the first portion of the digital content to the second client when the client declines the offer.

11. The digital content distribution system of claim 7, wherein the digital content is video-on-demand content.

12. A set-top box comprising:
a storage; and
a processor in communication with the storage, the processor configured to:
send a request to a server for digital content;
provide a viewer with an offer to miss a first portion of the digital content; and
receive a second portion of the digital content as a multicast stream.

13. The set-top box of claim 12, wherein the offer includes a discount, a credit, a rebate, or any combination thereof.

14. The set-top box of claim 12, wherein the processor is further configured to receive the first portion of the digital content when the offer is declined.

15. The set-top box of claim 14, wherein receiving the first portion of the digital content includes receiving a unicast stream from the server.

16. The set-top box of claim 12, wherein the digital content is video-on-demand content.

17. A method of receiving digital content, comprising:
sending a request to a server for digital content;
providing a viewer with an offer to miss a first portion of the digital content; and
receiving a second portion of the digital content as a multicast stream.

18. The method of claim 17, wherein the offer includes a discount, a credit, a rebate, or any combination thereof.

19. The method of claim 17, further comprising receiving the first portion of the digital content when the offer is declined.

20. The method of claim 19, wherein receiving the first portion of the digital content includes receiving a unicast stream from the server.

21. The method of claim 17, wherein the digital content is video-on-demand content.
